(19) United States
(12) Patent Application Publication
(10) Pub. No.: US 2017/0261678 A1
(43) Pub. Date: Sep. 14, 2017

(54) BACKLIGHT MODULE AND LIQUID CRYSTAL DISPLAY

(71) Applicant: Shenzhen China Star Optoelectronics Technology Co., Ltd., Shenzhen (CN)

(72) Inventor: Hu HE, Shenzhen (CN)

(21) Appl. No.: 14/913,826

(22) PCT Filed: Jan. 13, 2016
(86) PCT No.: PCT/CN2016/070825

§ 371 Date: Feb. 23, 2016

(30) Foreign Application Priority Data
Oct. 20, 2015 (CN) 201510685179.3

(51) Int. Cl. F21V 8/00

(52) U.S. Cl. CPC G02B 6/0055; G02B 6/0065; G02B 6/0085

(57) ABSTRACT

A backlight module including a light guide plate including a first surface and an incident surface disposed opposite to each other, a second surface and a third surface disposed opposite to each other and connected between the first surface and the incident surface, and a light emitting surface and a reflecting surface disposed opposite to each other and connected to the incident surface. The first surface, the second surface and the third surface; a light source disposed adjacent to the incident surface and a reflecting sheet including a flat part and a first bent part formed by bending a first side of the flat part, wherein the flat part is disposed under the reflecting surface, and the first bent part is attached to the first surface. A liquid crystal display having the backlight module is also disclosed.

### TECHNICAL FIELD

The present disclosure relates to liquid crystal display technical field, and more particularly, to a backlight module and a liquid crystal display (LCD).

### BACKGROUND ART

With the evolution of photoelectric and semiconductor technologies, the flourishing development of a flat panel display is driven, and in various flat panel displays, liquid crystal displays (LCDs) have been applied to many aspects of the production and living, because of having various superior characteristics, such as high space utilization, low power consumption, no radiation and low electro-magnetic interference or the like.

With the development of the liquid crystal display technology, the markets are increasingly seeking the thinning of the electronic devices, for example, the current electronic devices, such as a laptop, a mobile phone, a tablet computer, or the like, which need a liquid crystal display, are made thinner and thinner. Thus, the liquid crystal display needs to be made thinner and thinner. Currently, a major and urgent issue needed to be resolved is how to provide a thin liquid crystal display.

### SUMMARY

In order to achieve the above purpose, the present disclosure provides a backlight module including: a light guide plate including an incident surface, a first surface, a second surface, a third surface, a light emitting surface and a reflecting surface, wherein, the first surface is opposite to the incident surface, the second surface and the third surface are opposite to each other and each connected between the incident surface and the first surface, the light emitting surface and the reflecting surface are opposite to each other and each connected to the incident surface, the first surface, the second surface and the third surface; a light source disposed adjacent to the incident surface; and a reflecting sheet including a flat part and a first bent part formed by bending a first side of the flat part, wherein the flat part is disposed under the reflecting surface, and the first bent part is attached to the first surface.

Further, the reflecting sheet further includes a second bent part formed by bending a second side of the flat part, wherein the second bent part is attached to the second surface.

Further, the reflecting sheet further includes a third bent part formed by bending a third side of the flat part, wherein the third bent part is attached to the third surface.

Further, the first bent part and the first surface and/or the second bent part and the second surface and/or the third bent part and the third surface are attached to each other via a double-sided tape.

Further, a plurality of lattice points are disposed on the reflecting surface.

Further, a plurality of double-sided tapes are disposed on the flat part in staggered positions with the lattice points, and the flat part is attached to the reflecting surface via the plurality of double-sided tapes.

Further, the light guide plate is made of glasses.

Further, the light source is a light emitting diode.

Further, the backlight module further includes a heat radiator including a bearing part and a mounting part formed by bending a side of the bearing part, wherein an end of the flat part adjacent to the incident surface and an incident end of the light guide plate are hosted on the bearing part such that the mounting part is adjacent to the incident surface, and the light source is mounted on a surface of the mounting part facing the incident surface.

The present disclosure further provides a liquid crystal display having the above-described backlight module.

The advantageous effects of the present disclosure are as follows: the backlight module according to the present disclosure decreases its thickness by not using a back plate; and when the backlight module provided by the present disclosure is applied to the liquid crystal display, a thickness of the liquid crystal display may be greatly decreased, so that the liquid crystal display satisfies the currently thin-type requirement.

### BRIEF DESCRIPTION OF THE DRAWINGS

The above and/or other aspects, characteristics and advantages of the embodiments in the present disclosure will become more apparent from the following description, taken in conjunction with the accompanying drawings in which:

FIG. 1 is a side view and top view diagram illustrating a light guide plate according to an embodiment of the present disclosure;

FIG. 2 is a top view diagram illustrating a reflecting sheet according to an embodiment of the present disclosure;

FIG. 3 is a stereo diagram illustrating the assembling of the reflecting sheet and the light guide plate according to an embodiment of the present disclosure;

FIG. 4 is a structural schematic diagram illustrating a backlight module according to an embodiment of the present disclosure; and

FIG. 5 is a structural schematic diagram of a liquid crystal display according to an embodiment of the present invention.

### DETAILED DESCRIPTION OF EXEMPLARY EMBODIMENTS

Embodiments of the present disclosure will be described in detail below by referring to the accompany drawings. However, the present disclosure can be embodied in many different forms, and should not be construed as being limited to the specific embodiments set forth herein. Rather, these embodiments are provided for explaining the principle and actual application of the present disclosure, thus other skilled in the art can understand various embodiments and various amendments which are suitable for specific intended applications of the present disclosure.

In the drawings, thicknesses of layers and regions are exaggerated for clarity. The same reference numerals are used to indicate the same elements throughout the drawings.

It will be understood that although the terms “first”, “second”, “third”, etc. may be used herein to describe various elements, these elements should not be limited by these terms. These terms are merely used to distinguish one element from another.

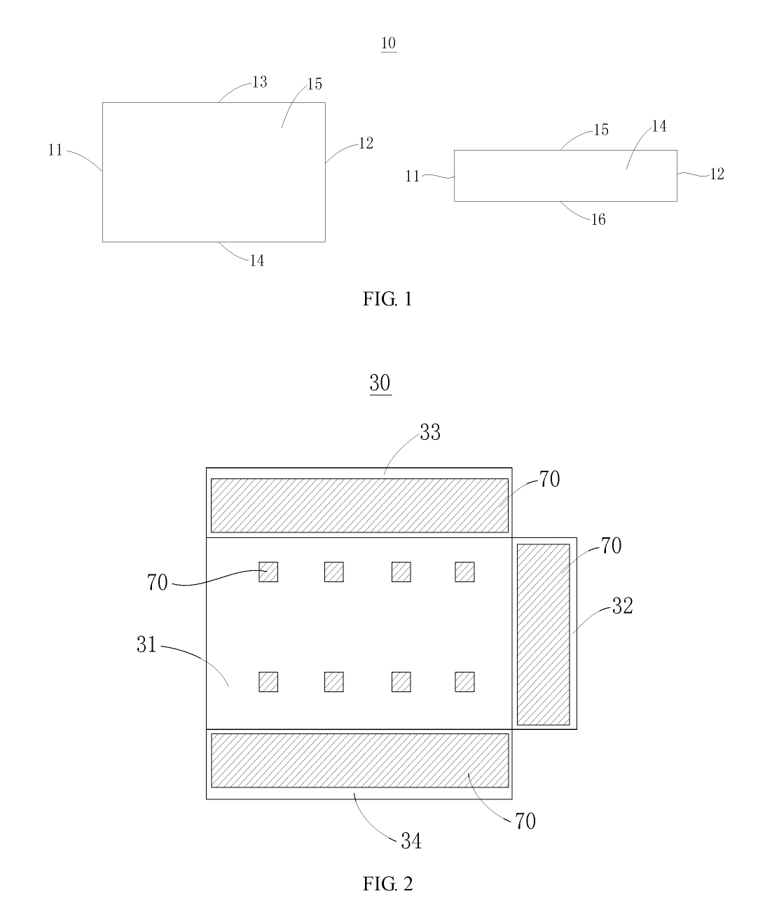

FIG. 1 is a side view and top view diagram illustrating a light guide plate according to an embodiment of the present disclosure. In FIG. 1, the left diagram is a top view diagram, and the right diagram is a side view diagram.

Referring to FIG. 1, the light guide plate 10 is a flat-type light guide plate, but the present disclosure is not limited thereto. For example, the light guide plate 10 may be a wedge-shaped light guide plate. The light guide plate 10 includes six surfaces having four side surfaces, and a top surface and a bottom surface disposed opposite to each other and each connected to the four side surfaces. In the present embodiment, it is designated that one of the four side surfaces is an incident surface 11; the side surface opposite to the incident surface 11 is a first surface 12; two side surfaces opposite to each other and connected between the incident surface 11 and the first surface 12 are a second surface 13 and a third surface 14, respectively; the top surface is designated to be a light emitting surface 15; and the bottom surface is designated to be a reflecting surface 16. Certainly, the definition here is merely a kind of exemplary embodiment, and the present disclosure is not limited thereto.

FIG. 2 is a top view diagram illustrating a reflecting sheet according to an embodiment of the present disclosure.

Referring to FIG. 2, a reflecting sheet 30 according to the embodiment of the present disclosure includes a flat part 31, and a first bent part 32, a second bent part 33 and a third bent part 34 formed by respectively bending three sides of the flat part 31. Before assembling the reflecting sheet 30 and the light guide plate 10, a double-sided tape 70 is disposed on each of the first bent part 32, the second bent part 33, and the third bent part 34, respectively. Certainly, in the present disclosure, the double-sided tape 70 may be replaced with other adhesives, such as glue or the like. In addition, a plurality of double-sided tapes 70 may be disposed on the flat part 31, and the specific function will be described below.

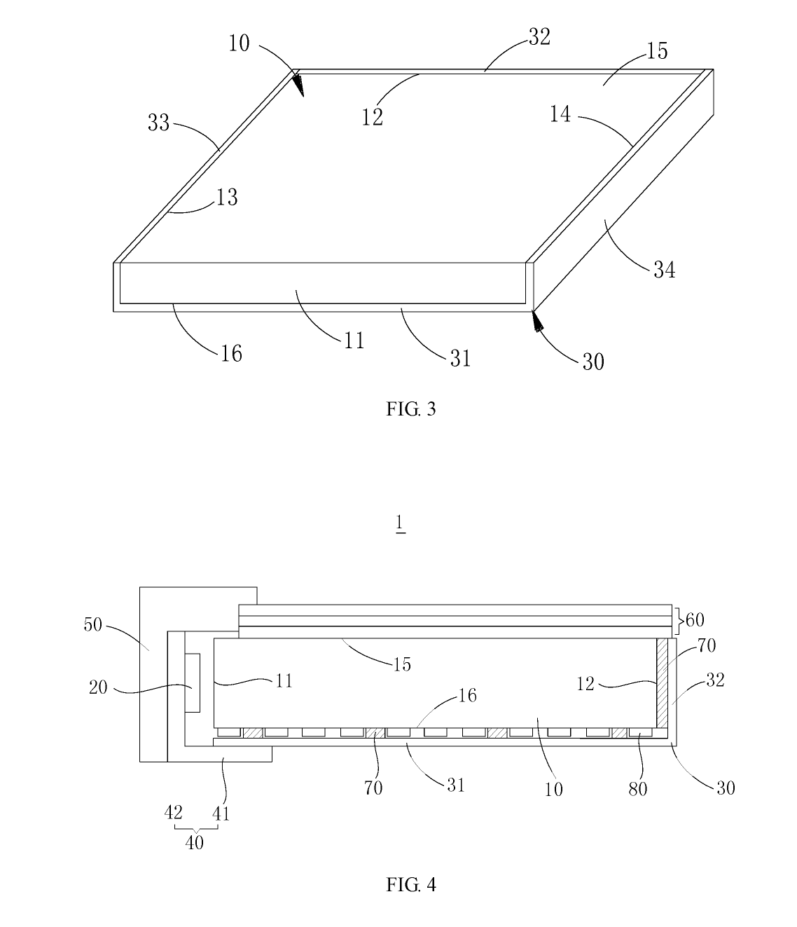

FIG. 3 is a stereo diagram illustrating the assembling of the reflecting sheet and the light guide plate according to an embodiment of the present disclosure.

Referring to FIG. 3, the flat part 31 is disposed under the reflecting surface 16, and the first bent part 32, the second bent part 33 and the third bent part 34 are attached to the first surface 12, the second surface 13 and the third surface 14 via the double-sided taps 70, respectively. As a result, a bonding firmness of the reflecting sheet 30 and the light guide plate 10 may be enhanced. Certainly, it should be understood that the effect of fixing the reflecting sheet 30 and the light guide plate 10 may also be achieved by bonding a bent part of the reflecting sheet 30 and a side surface of the light guide plate 10, or bonding two bent parts of the reflecting sheet 10 and two side surfaces of the light guide plate 10. For example, the first bent part 32 is bonded to the first surface 12; in this case, the reflecting sheet 30 may not include the second bent part 33 and the third bent part 34.

FIG. 4 is a structural schematic diagram illustrating a backlight module according to an embodiment of the present disclosure.

Referring to FIG. 4, a backlight module 1 according to the embodiment of the present disclosure includes: a light guide plate 10, a light source 20, a reflecting sheet 30, a heat radiator (or referred to as a heat sink) 40, a glue frame 50, and three optical film sheets 60.

In particular, the heat radiator 40 as a whole is in an “L” shape, including a bearing part 41 and a mounting part 42 formed by bending a side of the bearing part 41. After assembling the light guide plate 10 and the reflecting sheet 30 in the manner shown in FIG. 3, a side of the flat part 31 of the reflecting sheet 30 adjacent to the incident surface 11 and an incident end of the light guide plate 10 (i.e., an end having the incident surface 11) are sequentially hosted on the bearing part 41. As a result, the mounting part 42 is adjacent to the incident surface 11.

The light source 20 may be a light emitting diode LED, but the present disclosure is not limited thereto. The light source 20 is disposed on a surface of the mounting part 42 facing the incident surface 11 such that the light source 20 is adjacent to the incident surface 11.

The three optical film sheets 60 are sequentially disposed on the light emitting surface 15 in a direction far away from the light emitting surface 15 to improve light emitted from the light emitting surface 15. It should be understood that the number of the optical film sheets 60 of the present disclosure is not limited to three, which may be set according to practical situations.

The glue frame 50 is disposed on the three optical film sheets 60. The glue frame 50 is firmly fixed to the heat radiator 40 such that the three optical film sheets 60, the light guide plate 10, the light source 20 and the reflecting sheet 30 are fixed between the glue frame 50 and the heat radiator 40.

Further, in the present embodiment, a plurality of lattice points 80 are disposed on the reflecting surface 16, wherein shapes of the lattice points 80 are not specifically defined in the present embodiment. The flat part 31 of the reflecting sheet 30 may be attached to the reflecting surface 16 via the plurality of double-sided tapes 70 disposed on the flat part 31 when it is disposed opposite to the reflecting surface 16, thereby further improving the bonding firmness of the reflecting sheet 30 and the light guide plate 10. Here, it should be explained that the double-sided tapes 70 on the flat part 31 and the lattice points 80 are disposed in staggered positions.

In the present embodiment, the light guide plate 10 is made of transparent glass. Since the strength of the glass is much greater than that of the PMMA or MS or the like, the backlight module 1 according to the embodiment of the present disclosure may not include a back plate, and is supported merely by the strength of the light guide plate 10. Thus, in comparison with the prior art, when the backlight module 1 does not include the back plate, a thickness of the liquid crystal display formed by assembling the backlight module 1 and a liquid crystal panel will be greatly decreased, thereby satisfying a thin-type requirement of the liquid crystal display.

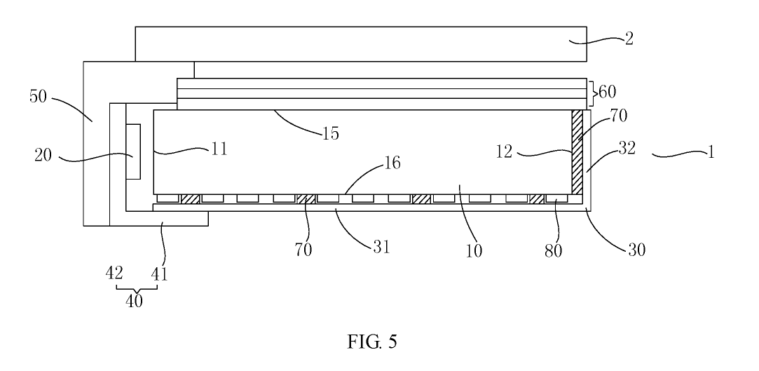

FIG. 5 is a structural schematic diagram of a liquid crystal display according to an embodiment of the present disclosure.

Referring to FIG. 5, the liquid crystal display according to the embodiment of the present disclosure includes: a liquid crystal panel 2, and the above backlight module 1 disposed opposite to the liquid crystal panel 2, wherein the backlight module 1 provides uniform surface light source to the liquid crystal panel 2 such that the liquid crystal panel 2 may display images by using the uniform surface light source.

Although the present disclosure has been shown and described with reference to the special exemplary embodiments, those skilled in the art will understand that various changes in form and details may be made therein without departing from the spirit and scope of the invention as defined by the appended claims and its equivalents.

What is claimed is:

1. A backlight module comprising:
a light guide plate including an incident surface, a first surface, a second surface, a third surface, a light emitting surface and a reflecting surface, wherein, the first surface is opposite to the incident surface, the second surface and the third surface are opposite to each other and each connected between the incident surface and the first surface, the light emitting surface and the reflecting surface are opposite to each other and each connected to the incident surface, the first surface, the second surface and the third surface;
a light source disposed adjacent to the incident surface; and
a reflecting sheet including a flat part and a first bent part formed by bending a first side of the flat part,
wherein the flat part is disposed under the reflecting surface, and the first bent part is attached to the first surface.

2. The backlight module of claim 1, wherein the reflecting sheet further comprises a second bent part formed by bending a second side of the flat part, wherein the second bent part is attached to the second surface.

3. The backlight module of claim 2, wherein the reflecting sheet further comprises a third bent part formed by bending a third side of the flat part, wherein the third bent part is attached to the third surface.

4. The backlight module of claim 3, wherein the first bent part and the first surface and/or the second bent part and the second surface and/or the third bent part and the third surface are attached to each other via a double-sided tape.

5. The backlight module of claim 1, wherein a plurality of lattice points are disposed on the reflecting surface.

6. The backlight module of claim 2, wherein a plurality of lattice points are disposed on the reflecting surface.

7. The backlight module of claim 3, wherein a plurality of lattice points are disposed on the reflecting surface.

8. The backlight module of claim 4, wherein a plurality of lattice points are disposed on the reflecting surface.

9. The backlight module of claim 5, wherein a plurality of double-sided tapes are disposed on the flat part in staggered positions with the lattice points, and the flat part is attached to the reflecting surface via the plurality of double-sided tapes.

10. The backlight module of claim 6, wherein a plurality of double-sided tapes are disposed on the flat part in staggered positions with the lattice points, and the flat part is attached to the reflecting surface via the plurality of double-sided tapes.

11. The backlight module of claim 7, wherein a plurality of double-sided tapes are disposed on the flat part in staggered positions with the lattice points, and the flat part is attached to the reflecting surface via the plurality of double-sided tapes.

12. The backlight module of claim 8, wherein a plurality of double-sided tapes are disposed on the flat part in staggered positions with the lattice points, and the flat part is attached to the reflecting surface via the plurality of double-sided tapes.

13. The backlight module of claim 1, wherein the light guide plate is made of glass.

14. The backlight module of claim 1, wherein the light source is a light emitting diode.

15. The backlight module of claim 1, wherein the backlight module further comprises:
a heat radiator including a bearing part and a mounting part formed by bending a side of the bearing part,
wherein an end of the flat part adjacent to the incident surface and an incident end of the light guide plate are hosted on the bearing part such that the mounting part is adjacent to the incident surface, and the light source is mounted on a surface of the mounting part facing the incident surface.

16. A liquid crystal display comprising a liquid crystal panel and a backlight module disposed opposite to each other, wherein the backlight module comprises:
a light guide plate including an incident surface, a first surface, a second surface, a third surface, a light emitting surface and a reflecting surface, wherein, the first surface is opposite to the incident surface, the second surface and the third surface are opposite to each other and each connected between the incident surface and the first surface, the light emitting surface and the reflecting surface are opposite to each other and each connected to the incident surface, the first surface, the second surface and the third surface;
a light source disposed adjacent to the incident surface; and
a reflecting sheet including a flat part and a first bent part formed by bending a first side of the flat part,
wherein the flat part is disposed under the reflecting surface, and the first bent part is attached to the first surface.
